(19) United States
(12) Patent Application Publication
(10) Pub. No.: US 2026/0346614 A1
(43) Pub. Date: Nov. 5, 2026

(54) PRINTING METHOD OF THERMAL PRINTER, PRINTING SYSTEM, AND STORAGE MEDIUM

(71) Applicant: PAX COMPUTER TECHNOLOGY (SHENZHEN) CO.,LTD., Shenzhen (CN)

(72) Inventors: Chuan LIU, Shenzhen (CN); Shengxiang TU, Shenzhen (CN)

(21) Appl. No.: 19/119,193

(22) PCT Filed: Jul. 27, 2023
(86) PCT No.: PCT/CN2023/109662

§ 371 Date: Apr. 8, 2025

(30) Foreign Application Priority Data
Oct. 10, 2022 (CN) 202211233834.8

(51) Int. Cl. B41J 2/32; G06K 15/02

(52) U.S. Cl. CPC B41J 2/32; G06K 15/028; G06K 15/1809

(57) ABSTRACT

Disclosed are a printing method of a thermal printer, a printer, a printing system, and a storage medium. The printing method comprises: acquiring N step time at a preset step interval from an acceleration table of a stepper motor, and arranging the N step time in an ascending order to form a deceleration table Gd of the stepper motor; calculating theoretical step time Tₘ of a current row m of points to be printed; and determining the step time of the current row m of said points depending on whether one or more step times less than the theoretical step time Tₘ exist in the deceleration table Gd. The printing method can prevent an excessively large amplitude in the deceleration of the thermal printer during printing, to ensure that the thermal printer consistently applies certain pulling force to paper, thereby preventing paper jams.

### CROSS-REFERENCE TO RELATED APPLICATIONS

This application claims priority to China Application No. 202211233834.8 filed on Oct. 10, 2022, in the China National Intellectual Property Administration, the contents of which are incorporated by reference herein.

### TECHNICAL FIELD

The present disclosure relates to thermal printer technology field, in particular to a printing method of thermal printer, a printing system, and a storage medium.

### BACKGROUND

Thermal printers are often used in supermarkets, convenience stores, hospitals and other places, which have certain requirements for printing effect and printing speed, in order to provide a better user experience, the printing speed of thermal printers is currently adjusted to the expected theoretical value using printer drivers. However, during the development and actual application process, it was found that when using the existing printer driver, paper jams will occur when printing, the root cause is that the printing speed changes too much, causing the printer to be unable to pull the paper.

In order to solve the problem that the printing speed changes too much and the thermal printer cannot maintain a certain pulling force on the paper, in the prior art, printer manufacturers provide an acceleration table to ensure that the printing speed of the thermal printer does not change too much when changing from slow to fast. However, it still cannot solve the problem that the printing speed changes too much when changing from fast to slow.

### SUMMARY OF THE INVENTION

The application provides a printing method of thermal printer, a printer, a printing system, and a storage medium.

On a first aspect of the application, providing a printing method of thermal printer, including: acquiring N step times at a preset step interval from an acceleration table of a stepper motor, and arranging the N step times in an ascending order to form a deceleration table Gd of the stepper motor, wherein N is a number of row of points to be printed; calculating a theoretical step time Tₘ of a current row m of points to be printed, wherein m=1, 2, . . . , N; determining the step time of the current row m of points to be printed depending on whether one or more step times less than the theoretical step time Tₘ exist in the deceleration table Gd.

In the one embodiment, determining the step time of the current row m of points to be printed depending on whether one or more step times less than the theoretical step time Tₘ exist in the deceleration table Gd, by: determining the step time of the current row m of points to be printed as the theoretical step time Tₘ when there is no one or more step times less than the theoretical step time Tₘ in the deceleration table Gd; acquiring a maximum step time Gdᵢ among the one or more step times when one or more step times less than the theoretical step time Tₘ exist in the deceleration table Gd, where i is an i^{th} value in the deceleration table Gd, i=1, 2, . . . , N; determining the step time of the current row m of points to be printed depending on whether N−i is greater than or equal to M, where M is the number of row of points to be printed, M=N, N−1, . . . , 0.

In the one embodiment, determining the step time of the current row m of points to be printed depending on whether N−i is greater than or equal to M, by: acquiring a heating time Ghₘ of the current row m of points to be printed; determining the step time of current row m of points to be printed as the maximum step time Gdᵢ when N−i is greater than or equal to M; acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N; determining the step time of the current row m of points to be printed as the theoretical step time Tₘ if each of the step times Gdₙ is greater than or equal to the heating time Ghₘ; otherwise, determining the step time of the current row m of points to be printed as Gdᵢ₊ₖ, where k=m−1.

In one embodiment, calculating a theoretical step time Tₘ of a current row m of points to be printed, by acquiring a heating time Ghₘ of the current row m of points to be printed; acquiring an acceleration step time T of the current row m of points to be printed in the acceleration table; determining whether the acceleration step time T of the current row m of points to be printed is greater than or equal to the heating time Ghₘ of the current row m of points to be printed; if yes, determining the theoretical step time Tₘ of the current row m of points to be printed as the acceleration step time T; if no, determining the theoretical step time Tₘ of the current row m of points to be printed as the heating time Ghₘ.

In one embodiment, acquiring the acceleration step time T of the current row m of points to be printed in the acceleration table, by: finding a position of the current row m−1 of points to be printed in the acceleration table, and finding a position of the current row m of points to be printed in the acceleration table according to the position of the current row m−1 of points to be printed; acquiring the acceleration step time T according to the position of the current row m of points to be printed.

On a second aspect of the application, providing a printer, including: a forming module configured to acquire N step times at a preset step interval from an acceleration table of a stepper motor, and arrange the N step times in an ascending order to form a deceleration table Gd of the stepper motor, wherein N is a number of row of points to be printed; a calculating module configured to calculate a theoretical step time Tₘ of a current row m of points to be printed, wherein m=1, 2, . . . , N; a determining module configured to determine the step time of the current row m of points to be printed depending on whether one or more step times less than the theoretical step time Tₘ exist in the deceleration table Gd.

In one embodiment, the determining module is specifically configured to determine the step time of the current row m of points to be printed as the theoretical step time Tₘ when there is no one or more step times less than the theoretical step time Tₘ in the deceleration table Gd; acquire a maximum step time Gdᵢ among the one or more step times when one or more step times less than the theoretical step time Tₘ exist in the deceleration table Gd, where i is an i^{th} value in the deceleration table Gd, i=1, 2, . . . , N; determine the step time of the current row m of points to be printed depending on whether N−i is greater than or equal to M, where M is the number of row of points to be printed, M=N, N−1, . . . , 0.

In one embodiment, the determining module determines the step time of the current row m of points to be printed depending on whether N−i is greater than or equal to M, by: acquiring a heating time Ghₘ of the current row m of points to be printed; determining the step time of current row m of points to be printed as the maximum step time Gdᵢ when N−i is greater than or equal to M; acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N; determining the step time of the current row m of points to be printed as the theoretical step time Tₘ if each of the step times Gdₙ is greater than or equal to the heating time Ghₘ; otherwise, determining the step time of the current row m of points to be printed as Gdᵢ₊ₖ, where k=m−1.

On a third aspect of the application, providing a printing system including a memory, a processor and a computer program stored in the memory and executable on the processor, wherein the processor implements the steps of the method as any embodiment of the first aspect when executing the computer program.

On a fourth aspect of the application, providing a computer-readable storage medium stores a computer program, wherein the computer program, when executed by a processor, implements the steps of the method as any embodiment of the first aspect.

### BRIEF DESCRIPTION OF THE DRAWINGS

In order to more clearly illustrate the technical solutions in the embodiments of the application, the drawings needed to be used in the description of the embodiments will be briefly introduced below. Obviously, the drawings in the following description are only some embodiments of the application, for those of ordinary skill in the art, other drawings can also be obtained based on these drawings without exerting creative efforts.

FIG. 1 is a schematic diagram of a semiconductor heating element in a thermal printer provided in an embodiment of the present application;

FIG. 2 is a schematic diagram of an implementation process of a printing method of the thermal printer provided in an embodiment of the present application;

FIG. 3 is a schematic diagram of a complete implementation process of a printing method of the thermal printer provided in an embodiment of the present application;

FIG. 4 is a schematic diagram of an acceleration table of a stepper motor provided in an embodiment of the present application;

FIG. 5 is a schematic diagram of a deceleration table of the stepper motor provided in an embodiment of the present application;

FIG. 6 is a schematic diagram of a heating time table provided in an embodiment of the present application;

FIG. 7 is a structural schematic diagram of a printer provided in an embodiment of the present application.

FIG. 8 is a structural schematic diagram of a printing system provided in an embodiment of the present application.

### DETAILED DESCRIPTION

In the following description, specific details such as specific system structures, technologies, etc. are provided for the purpose of illustration rather than limitation, so as to provide a thorough understanding of the embodiments of the present application. However, it should be clear to those skilled in the art that the present application may also be implemented in other embodiments without these specific details. In other cases, detailed descriptions of well-known systems, devices, circuits, and methods are omitted to prevent unnecessary details from obstructing the description of the present application.

In order to illustrate the technical solution described in this application, a specific embodiment is provided below for illustration.

Description of technical terms related to thermal printers:

### 1. Printing Row of Points:

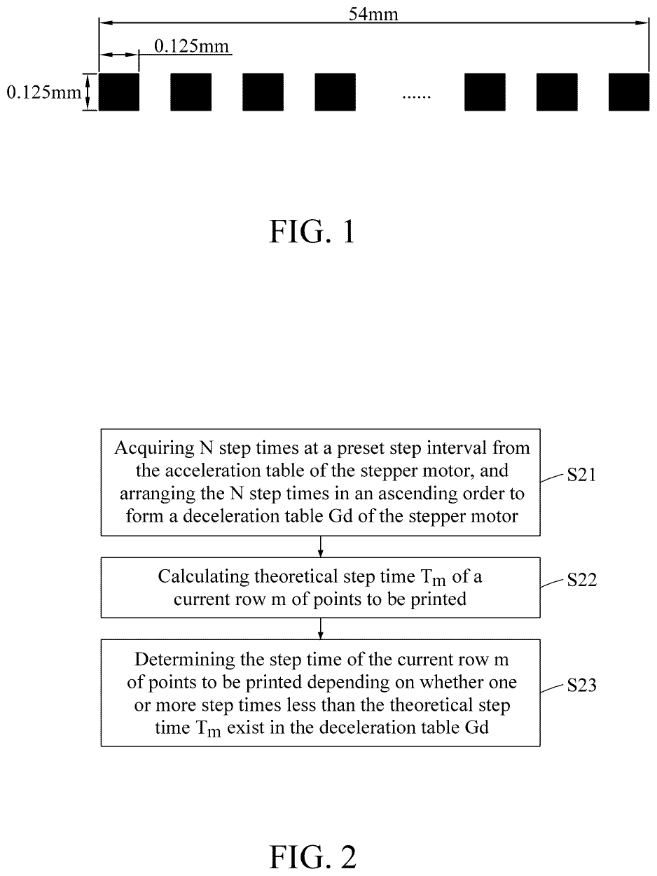

The thermal printer is equipped with a semiconductor heating element, as shown in FIG. 1, which is specifically a row of several equally spaced heating metals. For example, each heating metal has a specification of 0.125 mm×0.125 mm, and the spacing between the heating metals can be 0.125 mm, a length of the semiconductor heating element composed of all the heating metals is 54 mm. During the printing process, after the corresponding heating metal is heated, the heating metal contacts the thermal printing paper, and a chemical reaction occurs on the thermal printing paper, which turns black and prints out text and patterns. The row of points formed by the heating metal contacting the thermal printing paper each time is referred to as the printing row of points in the embodiment of the present application.

### 2. Stepper Motor:

The thermal printer has a stepper motor, which works with the semiconductor heating element, when the semiconductor heating element turns black when in contact with the thermal printing paper, the stepper motor pulls the thermal printing paper forward to print out text and patterns. It is understandable that in order to ensure the smooth printing of each printing row of points, the step time of the stepper motor must be greater than or equal to the heating time of the heating metal.

In the prior art, in order to increase the printing speed of thermal printers, people have designed printer drivers to adjust the heating time of the heated metal and the step time of the stepper motor, thereby adjusting the printing speed to the expected value. However, when using the printer driver to control the thermal printer to print, paper jams often occur, research has found that this is because the printing speed changes too much and the stepper motor cannot pull the paper forward in time. Therefore, in response to this problem, many printer manufacturers provide an acceleration table of the stepper motor for their printer products, when the printing speed of the stepper motor changes from low speed to high speed, it will accelerate according to the acceleration curve on the acceleration table, thereby avoiding excessive speed changes. However, the acceleration table still cannot solve the problem of excessive speed changes when the printing speed of the stepper motor changes from high speed to low speed, the thermal printers will still have paper jams during the printing process, affecting daily use.

Based on the problems existing in the prior art, the embodiments of the present application provide a printing method of thermal printer, a printer, a printing system and a storage medium, a deceleration table for the stepper motor is designed corresponding to the existing acceleration table. When the printing speed changes from fast to slow, the deceleration table is used to adjust the step time of the current row of points to be printed calculated by the existing acceleration table to ensure that the step time of the current row of points to be printed is greater than the step time in the deceleration table. This ensures that whether the current speed needs to be reduced and how much to reduce can be predicted in advance, and the problem of excessive change from fast to slow when the printing speed of the stepper motor is reduced can be avoided, ensuring that the stepper motor always maintains a certain pulling force on the paper, thereby reducing the chance of paper jams in the thermal printer.

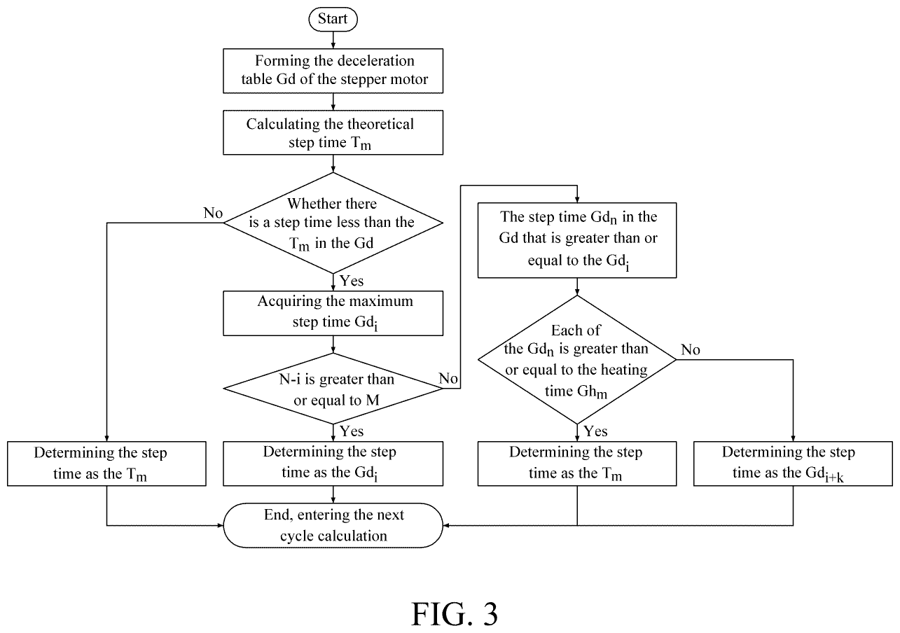

Referring to FIG. 2 and FIG. 3, an embodiment of the present application provides a printing method of thermal printer, including the following steps:

Step S21, acquiring N step times at a preset step interval from the acceleration table of the stepper motor, and arranging the N step times in an ascending order to form a deceleration table Gd of the stepper motor, wherein N is the number of row of points to be printed;

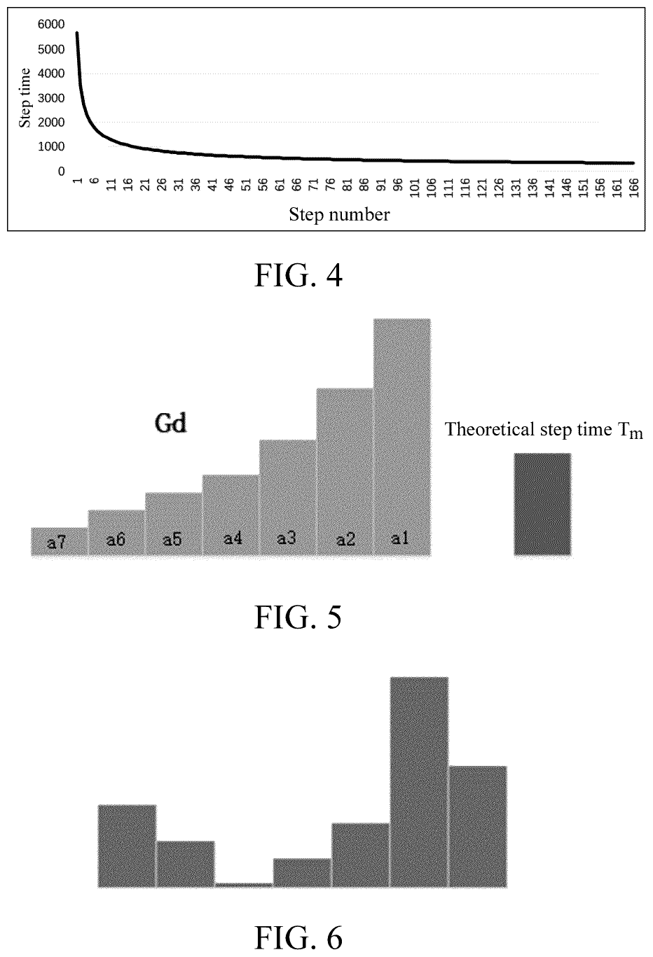

The acceleration table of the stepper motor is provided by the printer manufacturer for the thermal printer, the thermal printer will work according to the rules of the acceleration table. For example, as shown in FIG. 4, the embodiment of the present application provides an acceleration table of the stepper motor, a unit of the step time is microsecond. It can be seen from the acceleration table that when the printing speed of the stepper motor changes from slow to fast during the printing process, it will accelerate according to the acceleration curve of the acceleration table to achieve a gradual increase in the printing speed, and the printing speed change will not be too much. Therefore, based on the existing acceleration table, the embodiment of the present application creatively proposes a deceleration table, which uses the deceleration table to determine the step time of the stepper motor to ensure that the printing speed does not change too much during the process of changing the printing speed from fast to slow.

Specifically, the process of acquiring the deceleration table from the acceleration table is as follows: acquiring N step times from the acceleration table of the stepper motor according to the preset step interval, and the N step times are arranged from small to large to form a deceleration table Gd. N is the number of printing row of points, that is, the total number of row of points that need to be printed when completing a printing job, and each printing row of points corresponds to a step time, it takes N step times to complete a printing job, the change order of the N step times in the acceleration table is from large to small, and the change order of the N step times in the deceleration table is from small to large. It is worth noting that the deceleration table designed in the embodiment of the present application can select different preset step intervals and formulate different deceleration processes according to printers of different speeds and actual application needs to meet various deceleration requirements.

In order to more clearly illustrate the process of acquiring the deceleration table, the embodiment of the present application is exemplified in conjunction with the acceleration table of FIG. 4. For example, if 7 rows of points to be printed are required in a printing job, then 7 step times can be acquired in the acceleration table at 5 step intervals, that is, 7 corresponding step times a1, a2, a3, a4, a5, a6, and a7 are acquired at positions with step numbers of 1, 5, 10, 15, 20, 25, and 30 in the acceleration table. Arranging a1, a2, a3, a4, a5, a6, and a7 from small to large to form the deceleration table Gd, and the arrangement order of the 7 step times in the deceleration table Gd is a 7, a6, a5, a4, a3, a2, and a1, as shown in FIG. 5.

Step S22, calculating theoretical step time Tₘ of a current row m of points to be printed, wherein m=1, 2, . . . , N;

In some embodiments, step S22 specifically includes: acquiring the heating time Ghₘ of the current row m of points to be printed;

Acquiring the acceleration step time T of the current row m of points to be printed in the acceleration table;

Determining whether the acceleration step time T of the current row m of points to be printed is greater than or equal to the heating time Ghₘ of the current row m of points to be printed;

If yes, determining the theoretical step time Tₘ of the current row m of points to be printed as the acceleration step time T; if no, determining the theoretical step time Tₘ of the current row m of points to be printed as the heating time Ghₘ.

In step S22, the theoretical step time Tₘ of the current row m of points to be printed is the step time of the stepper motor to enter the next row of points to be printed after the step time of the currently printed row of points to be printed, in the embodiment of the present application, the next row of points to be printed is referred to as the current row m of points to be printed, where m=1, 2, . . . , N; the step time of the next row of points to be printed is referred to as the theoretical step time Tₘ, and one printing job includes N theoretical step times Tₘ.

Since the stepper motor is printed based on the acceleration table, no matter whether the stepper motor is accelerating or decelerating, the stepping time of the stepper motor can be calculated based on the acceleration table, the embodiment of the present application finds the position of the step time of the currently printed row of points in the acceleration table according to the step time of the currently printed row of points, and acquires the step time of the next row of points to be printed in the acceleration table, this step time is called the acceleration step time T of the current row m of points to be printed.

A printing job includes N heating times Ghₘ, FIG. 6 shows a heating schedule of a thermal printer, the heating time Ghₘ is random, the calculation of the heating time Ghₘ of the current row m of points to be printed adopts the heating algorithm of the existing printer, and the embodiment of the present application does not limit this.

The embodiment of the present application determines the theoretical step time Tₘ of the current row m of points to be printed by comparing the acceleration step time T and the heating time Ghₘ of the current row m of points to be printed. Specifically, in order to ensure that printing is completed smoothly, the step time must be greater than or equal to the heating time. Therefore, when the comparison shows that the acceleration step time T is greater than or equal to the heating time Ghₘ, the theoretical step time Tₘ of the current row m of points to be printed is determined as the acceleration step time T. When the comparison shows that the acceleration step time T is less than the heating time Ghₘ, the theoretical step time Tₘ of the current row m of points to be printed is determined as the heating time Ghₘ.

Step S23, determining the step time of the current row m of points to be printed depending on whether one or more step times less than the theoretical step time Tₘ exist in the deceleration table Gd.

In some embodiments, step S23 includes the following steps:

Step S231, determining the step time of the current row m of points to be printed as the theoretical step time Tₘ when there is no one or more step times less than the theoretical step time Tₘin the deceleration table Gd;

Step S232, acquiring a maximum step time Gdᵢ among the one or more step times when one or more step times less than the theoretical step time Tₘ exist in the deceleration table Gd, where i is the ith value in the deceleration table Gd, i=1, 2, . . . , N;

Step S233, determining the step time of the current row m of points to be printed depending on whether N−i is greater than or equal to M, where M is the number of row of points to be printed, M=N, N−1, . . . , 0.

In the embodiment of the present application, after the theoretical step time Tₘ of the current row of points to be printed is calculated according to the above step S22, by judging whether there are one or more step times less than the theoretical step time Tₘ in the deceleration table Gd, it is possible to determine whether to adjust the theoretical step time Tₘ and to what extent the theoretical step time Tₘ should be adjusted, the algorithm time complexity of this step is O (N). One or more means that there is one or more step times, when there is no one or more step times less than the theoretical step time Tₘ in the deceleration table Gd, it means that the current speed is very slow and no deceleration is needed, the step time of the current row m of points to be printed can be determined to be the theoretical step time Tₘ. When there are one or more step times less than the theoretical step time Tₘ in the deceleration table Gd, it is necessary to continue to determine whether to adjust the theoretical step time Tₘ based on whether N−i is greater than or equal to M. It can be understood that M in the embodiment of the present application is the number of row of points to be printed in a printing job, M=N, N−1, . . . 0, and the M value will gradually decrease until the printing is completed, there are no new row of points to be printed, and M becomes 0.

The embodiment of the present application exemplarily provides a case where there is a step time less than the theoretical step time Tₘ in the deceleration table Gd, as shown in FIG. 5, the left side is the deceleration table Gd of the stepper motor, and the right side is the theoretical step time Tₘ of the current row m of points to be printed, then there are four step times a7, a6, a5, and a4 less than the theoretical step time Tₘ in the deceleration table Gd, and the maximum value of the four step times is a4, which is recorded as the maximum step time Gdᵢ, a4 is the 4^{th} value in the deceleration table, i=4; continue to determine the step time of the current row m of points to be printed based on whether N−i is greater than or equal to M.

In some embodiments, step S233 includes the following steps:

Step S2331, acquiring the heating time Ghₘ of the current row m of points to be printed;

Step S2332, determining the step time of current row m of points to be printed as the maximum step time Gdᵢ when N−i is greater than or equal to M;

Step S2333, acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N;

Step S2334, determining the step time of the current row m of points to be printed as the theoretical step time Tₘ if each of the step times Gdₙ is greater than or equal to the heating time Ghₘ;

Step S2335, otherwise, determining the step time of the current row m of points to be printed as Gdᵢ₊ₖ, where k=m−1.

In the step S233, when the deceleration table Gd has a step time less than the theoretical step time Tₘ, the step time of the current row m of points to be printed is determined by determining whether N−i is greater than or equal to M, the time complexity of this step algorithm is O(N). When N−i is greater than or equal to M, it means that printing is about to end, and the deceleration operation can be performed directly, and the step time of the current row m of points to be printed is determined to be the maximum step time Gdᵢ.

When N−i is less than M, the i-th to N-th step time in the deceleration table Gd is compared with the heating time Ghₘ of the current row m of points to be printed, and the i-th to N-th step time is recorded as Gdₙ, n=i, i+1, . . . , N; if each step time Gdₙ is greater than or equal to the heating time Ghₘ, it means that the current printing speed is appropriate and does not need deceleration, determining the step time of the current row m of points to be printed to be the theoretical step time Tₘ; otherwise, determining the step time of the current row m of points to be printed to be Gdᵢ₊ₖ, where k=m−1, m=1~(N−i). Furthermore, in an actual printer driver, when it is determined that each step time Gdₙ is greater than or equal to the heating time Ghₘ, the deceleration flag can be set to 0, otherwise the deceleration flag is set to 1, the printer driver can adjust the step time of the stepper motor by determining the deceleration flag.

Combined with the above example, when N=7 and i=4, if N−i is less than M at this time, the i-N^{th} step time in the deceleration table Gd is compared with the heating time Ghₘ of the current row m of points to be printed, that is, a4, a3, a2, a1 are compared with Ghₘ. If a4, a3, a2, a1 are all greater than Ghₘ, it means that deceleration is not required, and the step time is determined to be the theoretical step time Tₘ; otherwise, the step time of the current row m of points to be printed is determined to be Gdᵢ₊ₖ.

It can be understood that after the above steps S231, S2332, S2334, and S2335 determine the step time of the current row m of points to be printed, regardless of whether the conclusion is that adjustment is needed, the process loops into determining the step time for the next row of points to be printed, re-executes the printing algorithm of the embodiment of the present application, and recalculates and updates the theoretical step time Tₘ and heating time Ghₘ.

It is worth mentioning that the time complexity of the algorithm of the embodiment of the present application is O(2N), which proves that the method of the embodiment of the present application can not only avoid the problem of printer paper jam, but also the method is simple to calculate and has a fast calculation speed.

It should be understood that the size of the serial numbers of the steps in the above embodiments does not mean the order of execution, the execution order of each process should be determined by its function and internal logic, and should not constitute any limitation on the implementation process of the embodiments of the present application.

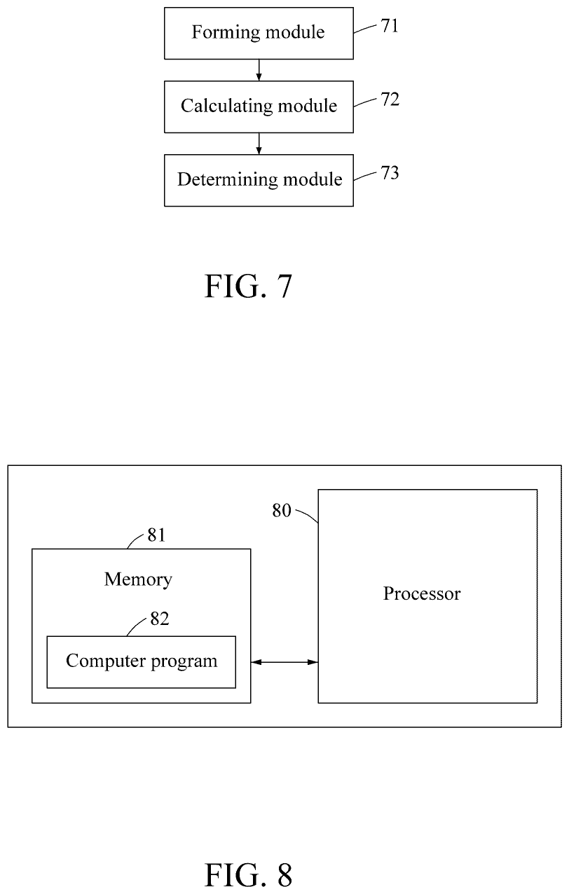

Referring to FIG. 7, a second aspect of the embodiment of the present application further provides a printer, including:

A forming module 71 is configured to acquire N step times at a preset step interval from the acceleration table of the stepper motor, and arrange the N step times in an ascending order to form a deceleration table Gd of the stepper motor, wherein N is the number of printing row of points;

A calculating module 72 is configured to calculate the theoretical step time Tₘ of a current row m of points to be printed, wherein m=1, 2, . . . , N;

A determining module 73 is configured to determine the step time of the current row m of points depending on whether one or more step times less than the theoretical step time Tₘ exist in the deceleration table Gd.

In some embodiments, the calculating module 72 is specifically configured to:
acquire the heating time Ghₘ of the current row m of points to be printed;
acquire the acceleration step time T of the current row m of points to be printed in the acceleration table;
determine whether the acceleration step time T of the current row m of points to be printed is greater than or equal to the heating time Ghₘ of the current row m of points to be printed;
If yes, determine the theoretical step time Tₘ of the current row m of points to be printed to be the acceleration step time T;
If no, determine the theoretical step time Tₘ of the current row m of points to be printed to be the heating time Ghₘ.

In some embodiments, the determining module 73 is specifically configured to:
determine the step time of the current row m of points to be printed as the theoretical step time Tₘ when there is no one or more step times less than the theoretical step time Tₘ in the deceleration table Gd;
acquire a maximum step time Gdᵢ among the one or more step times when one or more step times less than the theoretical step time Tₘ exist in the deceleration table Gd, where i is the i-th value in the deceleration table Gd, i=1, 2, . . . , N;
determine the step time of the current row m of points to be printed depending on whether N−i is greater than or equal to M, where M is the number of row of points to be printed, M=N, N−1, . . . , 0.

In some embodiments, determining the step time of the current row m of points to be printed depending on whether N−i is greater than or equal to M by:
acquiring the heating time Ghₘ of the current row m of points to be printed;
determining the step time of current row m of points to be printed as the maximum step time Gdᵢ when N−i is greater than or equal to M;
acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N;
determining the step time of the current row m of points to be printed as the theoretical step time Tₘ if each of the step times Gdₙ is greater than or equal to the heating time Ghₘ;
otherwise, determining the step time of the current row m of points to be printed as Gdᵢ₊ₖ, where k=m−1.

A thermal printer in an embodiment of the present application is a modular device corresponding to the printing method of the thermal printer in the above embodiment, its principle and implementation process are the same as those in the above embodiment. For details, please refer to the description of the method, which will not be described in detail here.

Referring to FIG. 8, a third aspect of the embodiment of the present application provides a printing system, including: a processor 80, a memory 81, and a computer program 82 stored in the memory 81 and executable on the processor 80. When the processor 80 executes the computer program 82, the steps of the printing method embodiment of the thermal printer are implemented. Alternatively, when the processor 80 executes the computer program 82, the functions of each module/unit in the thermal printer embodiment are implemented.

A fourth aspect of an embodiment of the present application provides a computer-readable storage medium, wherein the computer-readable storage medium stores a computer program, and when the computer program is executed by a processor, the steps of the printing method of the thermal printer are implemented.

Exemplarily, the computer program 82 may be divided into one or more modules/units, which are stored in the memory 81 and executed by the processor 80 to complete the present application. The one or more modules/units may be a series of computer program instruction segments capable of completing specific functions, which are used to describe the execution process of the computer program 82 in the thermal printer.

The processor 80 may be a central processing unit (CPU), or other general-purpose processors, a digital signal processors (DSP), an application-specific integrated circuits (ASIC), a field-programmable gate arrays (FPGA), or other programmable logic devices, discrete gate or transistor logic devices, discrete hardware components, etc. A general-purpose processor may be a microprocessor or any conventional processor, etc.

Those skilled in the art can clearly understand that for the convenience and simplicity of description, only the division of the above-mentioned functional units and modules is used as an example. In actual applications, the above-mentioned functions can be assigned to different functional units and modules as needed, that is, the internal structure of the device can be divided into different functional units or modules to complete all or part of the functions described above. The functional units and modules in the embodiments can be integrated into one processing unit, or each unit can exist physically separately, or two or more units can be integrated into one unit. The above-mentioned integrated unit can be implemented in the form of hardware or in the form of software functional units. In addition, the specific names of the functional units and modules are only for the convenience of distinguishing each other and are not used to limit the protection scope of this application. The specific working process of the units and modules in the above system can refer to the corresponding process in the above method embodiment, which will not be repeated here.

In the above embodiments, the description of each embodiment has its own emphasis. For parts that are not described or recorded in detail in a certain embodiment, reference can be made to the relevant descriptions of other embodiments.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of this application.

In the embodiments provided in the present application, it should be understood that the disclosed apparatus/terminal equipment and method can be implemented in other ways. For example, the apparatus/terminal equipment embodiments described above are only schematic, for example, the division of the modules or units is only a logical function division, and there may be other division methods in actual implementation, for example, multiple units or components can be combined or integrated into another system, or some features can be ignored or not executed. Another point is that the mutual coupling or direct coupling or communication connection shown or discussed may be an indirect coupling or communication connection through some interface, device or unit, which may be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solution of this embodiment.

In addition, each functional unit in each embodiment of the present application may be integrated into one processing unit, or each unit may exist physically separately, or two or more units may be integrated into one unit. The above-mentioned integrated unit may be implemented in the form of hardware or in the form of software functional units.

If the integrated module/unit is implemented in the form of a software functional unit and sold or used as an independent product, it can be stored in a computer-readable storage medium. Based on this understanding, the present application implements all or part of the processes in the above-mentioned embodiment method, and can also be completed by hardware related to computer program instructions. The computer program can be stored in a computer-readable storage medium, and when the computer program is executed by the processor, the steps of each of the above-mentioned method embodiments can be implemented. The computer program includes computer program code, which may be in source code form, object code form, executable file or some intermediate form, etc. The computer readable medium may include: any entity or device capable of carrying the computer program code, recording medium, USB flash drive, mobile hard disk, magnetic disk, optical disk, computer memory, read-only memory (ROM), random access memory (RAM), electric carrier signal, telecommunication signal and software distribution medium, etc. It should be noted that the content contained in the computer-readable medium can be appropriately increased or decreased according to the requirements of legislation and patent practices in the jurisdiction. For example, in some jurisdictions, according to legislation and patent practices, computer-readable media does not include electrical carrier signals and telecommunication signals.

The embodiments described above are only used to illustrate the technical solutions of the present application, rather than to limit them. Although the present application has been described in detail with reference to the aforementioned embodiments, a person skilled in the art should understand that the technical solutions described in the aforementioned embodiments may still be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

1. A printing method of thermal printer, comprising:
acquiring N step times at a preset step interval from an acceleration table of a stepper motor, and arranging the N step times in an ascending order to form a deceleration table Gd of the stepper motor, wherein N is a number of row of points to be printed;
calculating a theoretical step time Tₘ of a current row m of points to be printed, wherein m=1, 2, . . . , N;
determining the step time of the current row m of points to be printed depending on whether one or more step times less than the theoretical step time Tₘ exist in the deceleration table Gd.

2. The printing method of thermal printer according to claim 1, wherein determining the step time of the current row m of points to be printed depending on whether one or more step times less than the theoretical step time Tₘ exist in the deceleration table Gd, by:
determining the step time of the current row m of points to be printed as the theoretical step time Tₘ when there is no one or more step times less than the theoretical step time Tₘ in the deceleration table Gd;
acquiring a maximum step time Gdᵢ among the one or more step times when one or more step times less than the theoretical step time Tₘ exist in the deceleration table Gd, where i is an i^{th} value in the deceleration table Gd, i=1, 2, . . . , N;
determining the step time of the current row m of points to be printed depending on whether N−i is greater than or equal to M, where M is the number of row of points to be printed, M=N, N−1, . . . , 0.

3. The printing method of thermal printer according to claim 2, wherein determining the step time of the current row m of points to be printed depending on whether N−i is greater than or equal to M, by:
acquiring a heating time Ghₘ of the current row m of points to be printed;
determining the step time of current row m of points to be printed as the maximum step time Gdᵢ when N−i is greater than or equal to M;
acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N;
determining the step time of the current row m of points to be printed as the theoretical step time Tₘ if each of the step times Gdₙ is greater than or equal to the heating time Ghₘ;
otherwise, determining the step time of the current row m of points to be printed as Gdᵢ₊ₖ, where k=m−1.

4. The printing method of thermal printer according to claim 1, wherein calculating a theoretical step time Tₘ of a current row m of points to be printed, by
acquiring a heating time Ghₘ of the current row m of points to be printed;
acquiring an acceleration step time T of the current row m of points to be printed in the acceleration table;
determining whether the acceleration step time T of the current row m of points to be printed is greater than or equal to the heating time Ghₘ of the current row m of points to be printed;
if yes, determining the theoretical step time Tₘ of the current row m of points to be printed as the acceleration step time T;
if no, determining the theoretical step time Tₘ of the current row m of points to be printed as the heating time Ghₘ.

5. The printing method of thermal printer according to claim 4, wherein acquiring the acceleration step time T of the current row m of points to be printed in the acceleration table, by:
finding a position of the current row m−1 of points to be printed in the acceleration table, and finding a position of the current row m of points to be printed in the acceleration table according to the position of the current row m−1 of points to be printed;
acquiring the acceleration step time T according to the position of the current row m of points to be printed.

6-8. (canceled)

9. A printing system comprises a memory, a processor and a computer program stored in the memory and executable on the processor, wherein the when executing the computer program, the processor implements:
acquiring N step times at a preset step interval from an acceleration table of a stepper motor, and arranging the N step times in an ascending order to form a deceleration table Gd of the stepper motor, wherein N is a number of row of points to be printed;
calculating a theoretical step time Tₘ of a current row m of points to be printed, wherein m=1, 2, . . . , N;
determining the step time of the current row m of points to be printed depending on whether one or more step times less than the theoretical step time Tₘ exist in the deceleration table Gd.

10. A computer-readable storage medium stores a computer program, wherein the computer program, when executed by a processor, implements:
acquiring N step times at a preset step interval from an acceleration table of a stepper motor, and arranging the N step times in an ascending order to form a deceleration table Gd of the stepper motor, wherein N is a number of row of points to be printed;
calculating a theoretical step time Tₘ of a current row m of points to be printed, wherein m=1, 2, . . . , N;
determining the step time of the current row m of points to be printed depending on whether one or more step times less than the theoretical step time Tₘ exist in the deceleration table Gd.

11. The printing system according to claim 9, wherein determining the step time of the current row m of points to be printed depending on whether one or more step times less than the theoretical step time Tₘ exist in the deceleration table Gd, by:
determining the step time of the current row m of points to be printed as the theoretical step time Tₘ when there is no one or more step times less than the theoretical step time Tₘ in the deceleration table Gd;
acquiring a maximum step time Gdᵢ among the one or more step times when one or more step times less than the theoretical step time Tₘ exists in the deceleration table Gd, where i is an i^{th} value in the deceleration table Gd, i=1, 2, . . . , N;
determining the step time of the current row m of points to be printed depending on whether N−i is greater than or equal to M, where M is the number of row of points to be printed, M=N, N−1, . . . , 0.

12. The printing system according to claim 11, wherein determining the step time of the current row m of points to be printed depending on whether N−i is greater than or equal to M, by:
acquiring a heating time Ghₘ of the current row m of points to be printed;
determining the step time of current row m of points to be printed as the maximum step time Gdᵢ when N−i is greater than or equal to M;
acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N;
determining the step time of the current row m of points to be printed as the theoretical step time Tₘ if each of the step times Gdₙ is greater than or equal to the heating time Ghₘ;
otherwise, determining the step time of the current row m of points to be printed as Gdᵢ₊ₖ, where k=m−1.

13. The printing system according to claim 9, wherein calculating a theoretical step time Tₘ of a current row m of points to be printed, by acquiring a heating time Ghₘ of the current row m of points to be printed;
acquiring an acceleration step time T of the current row m of points to be printed in the acceleration table;
determining whether the acceleration step time T of the current row m of points to be printed is greater than or equal to the heating time Ghₘ of the current row m of points to be printed;
if yes, determining the theoretical step time Tₘ of the current row m of points to be printed as the acceleration step time T;
if no, determining the theoretical step time Tₘ of the current row m of points to be printed as the heating time Ghₘ.

14. The printing system according to claim 13, wherein acquiring the acceleration step time T of the current row m of points to be printed in the acceleration table, by:
finding a position of the current row m−1 of points to be printed in the acceleration table, and finding a position of the current row m of points to be printed in the acceleration table according to the position of the current row m−1 of points to be printed;
acquiring the acceleration step time T according to the position of the current row m of points to be printed.

15. The computer-readable storage medium according to claim 10, wherein determining the step time of the current row m of points to be printed depending on whether one or more step times less than the theoretical step time Tₘ exist in the deceleration table Gd, by:
determining the step time of the current row m of points to be printed as the theoretical step time Tₘ when there is no one or more step times less than the theoretical step time Tₘ in the deceleration table Gd;
acquiring a maximum step time Gdᵢ among the one or more step times when one or more step times less than the theoretical step time Tₘ exists in the deceleration table Gd, where i is an ith value in the deceleration table Gd, i=1, 2, . . . , N;
determining the step time of the current row m of points to be printed depending on whether N−i is greater than or equal to M, where M is the number of row of points to be printed, M=N, N−1, . . . , 0.

16. The computer-readable storage medium according to claim 15, wherein determining the step time of the current row m of points to be printed depending on whether N−i is greater than or equal to M, by:
acquiring a heating time Ghₘ of the current row m of points to be printed;
determining the step time of current row m of points to be printed as the maximum step time Gdᵢ when N−i is greater than or equal to M;
acquiring step times Gdₙ in the deceleration table Gd that is greater than or equal to the maximum step time Gdᵢ when N−i is less than M, and determining whether each of the step times Gdₙ is greater than or equal to the heating time Ghₘ, where n=i, i+1, . . . , N;
determining the step time of the current row m of points to be printed as the theoretical step time Tₘ if each of the step times Gdₙ is greater than or equal to the heating time Ghₘ;
otherwise, determining the step time of the current row m of points to be printed as Gdᵢ₊ₖ, where k=m−1.

17. The computer-readable storage medium according to claim 10, wherein calculating a theoretical step time Tₘ of a current row m of points to be printed, by
acquiring a heating time Ghₘ of the current row m of points to be printed;
acquiring an acceleration step time T of the current row m of points to be printed in the acceleration table;
determining whether the acceleration step time T of the current row m of points to be printed is greater than or equal to the heating time Ghₘ of the current row m of points to be printed;
if yes, determining the theoretical step time Tₘ of the current row m of points to be printed as the acceleration step time T;
if no, determining the theoretical step time Tₘ of the current row m of points to be printed as the heating time Ghₘ.

18. The computer-readable storage medium according to claim 17, wherein acquiring the acceleration step time T of the current row m of points to be printed in the acceleration table, by:
finding a position of the current row m−1 of points to be printed in the acceleration table, and finding a position of the current row m of points to be printed in the acceleration table according to the position of the current row m−1 of points to be printed;
acquiring the acceleration step time T according to the position of the current row m of points to be printed.
